(19) United States
(12) Patent Application Publication
(10) Pub. No.: US 2009/0010388 A1
(43) Pub. Date: Jan. 8, 2009

(54) MICROPLATE AND METHODS OF USING THE SAME

(76) Inventors: BARBARA C. STAHLY, West Lafayette, IN (US); Alice Wernicki, West Lafayette, IN (US)

Correspondence Address: O''BRIEN JONES, PLLC, 8200 Greensboro Drive, Suite 1020A, McLean, VA, 22102, US

(21) Appl. No.: 12/133,639

(22) Filed: Jun. 5, 2008

Related U.S. Application Data
(60) Provisional application No. 60/942,445, filed on Jun. 6, 2007.

(51) Int. Cl. G01N 21/01; G01N 23/20

(52) U.S. Cl. 378/79; 356/301

(57) ABSTRACT

Microplates having a body defining a plurality of wells, wherein the wells have at least one bottom portion configured to allow the sample to be analyzed by various methods in situ with minimized background interference in the data obtained, and methods of using the same, are disclosed. The improved microplate may also have wells having certain shapes and/or sizes to allow the sample to be analyzed with minimized background interference in the data obtained. A system for obtaining high-quality XRPD or Raman data is also disclosed.

This application claims priority to U.S. Provisional Patent Application No. 60/942,445, filed Jun. 6, 2007.

### TECHNICAL FIELD

The invention described herein relates to a method for identifying and characterizing solid forms of a compound by screening and analyzing products using a microplate. The invention also relates to systems and methods for obtaining XRPD and Raman data.

### BACKGROUND

As is well known, many organic and inorganic compounds can exist in the solid phase as, for example, crystalline, quasi-crystalline, nanocrystalline, and/or amorphous solids. These different solid phases may also exhibit different solid forms. The existence of different solid forms of a compound is important because the physical form of a solid can affect its properties, such as, for example, solubility, water sorption and desorption properties, particle size, hardness, drying characteristics, flow and filterability, compressibility, and density. Different solid forms can have different melting points, spectral properties, and thermodynamic stability. In the field of pharmaceuticals, for example, understanding whether a new chemical entity exists in different solid forms (e.g. different salt forms, cocrystals, polymorphs, solvates, and/or hydrates) is important. This is particularly true in the pre-formulation stage of development because in a drug substance, variations in properties associated with different forms can lead to differences in dissolution rate, oral absorption, bioavailability, levels of gastric irritation, toxicology results, and clinical trial results, for example. Ultimately, both safety and efficacy are impacted by properties that vary among different solid forms. Accordingly, the importance of screening a compound for solid forms (“screening”) is commonly understood.

Screening may be a function of time and effort, with the quality or results of screening being a function of the number of samples prepared and/or analyzed as well as the quality of preparation and/or analysis underlying those samples. Therefore, it is generally desirable to use numerous experimental parameters during a screen of a compound in order to maximize the number of viable solid forms identified and characterized. This generally requires that a very large number of experiments be performed.

One traditional way to screen a compound to determine whether it exists in multiple solid forms is to use individual glass vials for each experiment. Once the experiment is complete, the sample is then transferred to an appropriate holder and labelled before analysis using techniques such as, for example, X-ray powder diffraction (XRPD), Raman spectroscopy including Raman microscopy, infrared spectroscopy (IR) including IR microscopy, near IR, or optical microscopy. One disadvantage associated with this method, however, is the amount of time and labor it takes to prepare each sample, i.e. to put the compound of interest, appropriate solvent, and any other desired component of the experiment into individual vials, and then to transfer it to the appropriate holder, label it, and perform the desired analytical technique or techniques. If a large number of experiments is to be performed, the amount of time required to run a screen with this method may be prohibitive. Another disadvantage is that this method requires a relatively large amount of material for each experiment.

Accordingly, it is known to use a “microtiter plate” or a “microplate,” which is an apparatus comprising a plurality of wells. Each well of a microplate can typically hold in the range of a few to a few hundred microliters of liquid or more. The microplates, which are often made of polystyrene or polypropylene, can be clear or opaque.

Using a microplate, the compound of interest, appropriate solvent, and any other desired component of the experiment can be placed in each of the wells. Such microplates, which typically comprise 6, 24, 96, 384, or even 1536 or more wells arranged in an array, thus allow multiple experiments to be run simultaneously. This procedure thus significantly reduces the amount of time and labor required to perform the desired large number of experiments in a screen.

Once the experiments are completed and the solvent is removed, the samples in the microplate can be analyzed in situ, thereby eliminating the step of transferring the sample to a holder. This also allows for a smaller amount of materials to be used in each experiment. One disadvantage associated with conventional microplates, however, is that when the sample is analyzed in situ, for example by XRPD or Raman, the material that the microplate is composed of can interfere with the analysis, for example at the well bottom or microplate bottom (“bottom portion”). This can, for example, produce unwanted spectral interference in or contribution to the analytical data, such as the Raman spectrum or XRPD pattern, which can significantly affect the quality of the data obtained.

There is thus a continuous need for improved screening processes having increased reliability and efficiency. A need exists for a method by which a screen can be performed in a microplate, thereby allowing for multiple experiments to be run simultaneously, which also allows for the analysis of the sample directly in the microplate with minimized background interference, e.g. spectral interference or unwanted contribution, in the analytical data from the material which the microplate is composed of. This can, in turn, produce higher quality and more useful analytical data.

Although the present invention may obviate one or more of the above-mentioned disadvantages, it should be understood that some aspects of the invention might not necessarily obviate one or more of those disadvantages.

In the following description, various aspects and embodiments will become evident. In its broadest sense, the invention could be practiced without having one or more features of these aspects and embodiments. Further, these aspects and embodiments are exemplary. Additional objects and advantages of the invention will be set forth in part in the description which follows, and in part will be obvious from the description, or may be learned by practicing of the invention. The objects and advantages of the invention will be realized and attained by means of the elements and combinations particularly pointed out in the appended claims.

### SUMMARY OF THE INVENTION

In accordance with exemplary embodiments of the invention, the inventors have discovered that by using an improved microplate wherein a bottom portion is configured, e.g. comprised of a material with sufficient composition and thickness, to allow the sample to be analyzed in situ by various methods such as, for example, XRPD, Raman, IR, near IR, and/or optical microscopy, with minimized background interference from the bottom portion in the analysis, higher quality analytical data can be obtained than by using the microplates of the prior art. The inventors have also discovered that by providing wells having certain configurations (e.g. size and/or shape), the quality of the analytical data may also be improved. The inventors have also discovered that by modifying an XRPD or Raman system using the improved microplate, the quality of the XRPD or Raman data obtained may also be improved.

According to one exemplary embodiment of the invention, a bottom portion may be comprised of a material which minimizes background interference in or contributes relatively little background interference to, for example, an XRPD pattern or Raman spectrum obtained on a sample in the microplate well. The material can also optionally be chosen to increase the chemical compatibility with the solvents of interest for use in the screening process. In one embodiment, for example, this material can be polypropylene, which may optionally be in the form of a film. In other exemplary embodiments, the bottom portion may be chosen from any other suitable material or materials which allow the quality of the analytical data obtained to be improved, such as, for example, the polyimide film sold under the trade name Kapton® by DuPont or the polyester film sold under the trade name Mylar® by DuPont. In further exemplary embodiments, the bottom portion may be chosen from a material having low or zero crystallinity. For example, in one exemplary embodiment the bottom portion may be chosen from off-cut sheets of single crystals of quartz. In yet further exemplary embodiments, the bottom portion may be chosen from a mixture of materials which together allow the quality of the analytical data obtained to be improved, such as, for example, two or more thin polymer membranes bonded together.

According to another exemplary embodiment of the invention, the thickness of the bottom portion may be chosen such that the bottom portion minimizes background interference in, for example, an XRPD pattern or Raman spectrum obtained on a sample in the well, while retaining impermeability to the solvents of interest for use in the screening process. In one embodiment, for example, the thickness of the bottom portion can be in the range of about 1 micron to about 1 millimeter, such as ranging from about 3 microns to about 100 microns, or ranging from about 6 microns to about 50 microns. In one embodiment, for example, the thickness of the bottom portion may be about 37.5 microns.

In another exemplary embodiment of the invention, the thickness of the sides of the wells is chosen so that the sides of the wells are sufficiently thin to allow transfer of heat, if desired, but thick enough to allow appropriate manufacture.

According to another exemplary embodiment of the invention, the well of a microplate can be configured (e.g., have a shape and/or size) so as to minimize the amount of background interference from the well itself, such as from the sides of the well. Additionally, the well may optionally be configured so as to improve other aspects of the invention, such as, for example, to achieve maximum well volume and optimal size, shape, and placement of the solid in the well. In one embodiment, for example, the shape of the well can be chosen so that the top portion of the well is cylindrical, while the lower portion of the well is frustoconical. In another embodiment, for example, the shape of the well can be chosen so that the top portion of the well is frustoconical, while the lower portion of the well is cylindrical. In other exemplary embodiments, the wells may be cylindrical, conical, half- or partial-sphere (referred to as “round-bottomed” or “U-bottomed”), frustoconical, or any other shape which aids in reducing or minimizing the amount of background interference from the well, such as, for example, from the sides of the well. By cylindrical, it is meant that the well has an approximately uniform cross-section (lying in a plane which intersects a longitudinal axis of the well at a perpendicular angle) from the top of the well to the bottom of the well along its length. For example, the cylinder may have a circular-, elliptical-, rectangular-, or square-shaped cross-section. By frustoconical it is meant the frustum shape created by slicing the point off a cone (with the cut made parallel to the base). In exemplary embodiments, the sides of the well may optionally be smooth, for example to avoid the nucleation of solid material on the side of the well.

In another exemplary embodiment, the size of the microplate and/or wells may be increased or decreased as necessary to practice the invention, depending for example, on the type of analysis to be performed or the amount of material to be used. For example, in one exemplary embodiment, the height or depth of the well may be decreased to improve the quality of Raman data obtained. In another exemplary embodiment, the width of the well may be increased to improve the quality of Raman data obtained.

In one exemplary embodiment the microplate may be integrally made, i.e. may be one piece, and may be made by any method useful for making a one-piece microplate, such as, for example, injection molding or blow molding, as long as the specifications are such that the bottom portion is configured to minimize background interference in the analytical data obtained. For example, the bottom portion of the well in the injection molding process may optionally be made thinner than in traditional injection molding processes for making microplates.

In another exemplary embodiment, the microplate may be more than one piece (i.e. may be multi-piece), such as, for example, two pieces. In one embodiment, for example, the microplate body may be made separately from the bottom portion of the wells, and the wells of the microplate may optionally have openings (e.g., holes) at both ends. A bottom portion configured to minimize background interference in the analytical data obtained may be subsequently attached to the body of the microplate by, for example, mechanical means, heat sealing, or laser sealing, or any other sealing method known to those having skill in the art. In one exemplary embodiment, the body of the microplate may be made of polypropylene and the wells may define openings, with the bottom portion configured to cover the openings. By way of example only, the bottom portion may comprise a thin, for example ranging from about 25 to about 37.5 microns, film of polypropylene that is attached to the microplate body by heat sealing.

Except as otherwise set forth herein, the dimensions of the microplates and wells according to the invention may, for example, generally comply with the standards published by the American National Standards Institute (ANSI) for the Society for Biomolecular Screening (SBS) within industry-acceptable tolerances, or may, for example, generally be any dimensions which are used in the microplate field. However, as described above, the dimensions of the wells may be increased or decreased as necessary to practice the invention.

Microplates according to various aspects of the present teachings may thus provide a method for obtaining improved analytical data, such as, for example, improved XRPD or Raman data, on a sample, and/or may provide a method for reducing the amount of background interference in the analytical data obtained, such as, for example, XRPD or Raman data.

In another embodiment of the invention, a system for obtaining improved transmission and/or reflection XRPD data using a microplate according to exemplary embodiments of the invention is also disclosed. For example, in an exemplary transmission XRPD system a microplate defining a plurality of wells each having a bottom portion configured to allow for transmission of X-rays during XRPD analysis with minimized background interference in the XRPD data may be loaded into a plate holder of an X-ray diffractometer so that X-rays can be transmitted into an opening at one end of each of the wells and analyzed by a detector at the other, opposite end of each of the wells. In exemplary systems according to various aspects of the present teachings, the quality of the XRPD data obtained may be improved over methods and microplates used in the prior art, which may be a result of minimized background interference in the data from the bottom portion.

In another embodiment of the invention, a system for obtaining improved Raman data using a microplate according to exemplary embodiments of the invention is also disclosed. For example, in an exemplary Raman system, a microplate defining a plurality of wells each having a sufficiently large well opening to allow insertion of a Raman microprobe and/or a bottom portion configured to allow for Raman analysis through the well plate material with minimized background interference in the Raman data. In exemplary systems according to various aspects of the present teachings, the quality of the Raman data obtained may be improved over methods and microplates used in the prior art, which may be a result of minimized background interference from the bottom portion.

Systems according to various aspects of the present teachings may thus provide a method for obtaining improved analytical data, such as, for example, improved XRPD or Raman data, on a sample, and/or may provide a method for reducing the amount of background interference in the analytical data obtained, such as, for example, XRPD or Raman data.

As used herein, the term “solid form” may refer to different salt forms, cocrystals, polymorphs, solvates, and/or hydrates.

As used herein, the term “minimize,” “minimizing,” “minimized,” “reduce,” “reducing,” “reduced,” or “contributes relatively little to” when referring to the amount of background interference in the analytical data obtained, such as, for example, an XRPD pattern or Raman spectrum, refers to any appreciable reduction in the amount of background interference when compared to data obtained using methods and microplates of the prior art. Such an appreciable reduction will be understood by those skilled in the art and will assist in the analysis of resulting diffractograms or spectra.

For example, as one non-limiting and exemplary way to determine whether there is any appreciable reduction in the amount of background interference when compared to data obtained using methods and microplates of the prior art, one skilled in the art can, for example, visually examine data obtained according to various aspects of the present invention and compare it to data obtained using methods and microplates according to the prior art. For example, an XRPD pattern taken on a sample in a microplate according to the prior art may be compared against an XRPD pattern taken on a sample in an improved microplate according to various aspects of the present teachings, and one skilled in the art can then visually examine the data to determine whether the background interference is appreciably reduced. It should be noted, however, that an appreciable reduction in background interference can be any reduction that is appreciable to those skilled in the art, and is not limited to, for example, any exemplary appreciable reduction by visual inspection disclosed herein.

As used herein, “background interference” is meant to include unwanted additional data points other than those attributable to the sample, such as, for example, unwanted spectral interference in a Raman spectrum or unwanted background contribution to an XRPD pattern. The term “background interference” as used herein is also intended to include unwanted physical interference in the data obtained.

The term “improved” or “higher quality” when referring to the quality of analytical data, such as, for example, improved XRPD or Raman data, likewise refers to any appreciable reduction, as recognized by those of skill in the art, in the amount of background interference when compared to methods and microplates of the prior art.

As used herein, the term “microplate” generally refers to a well-plate apparatus comprising a plurality of wells, but it is contemplated that other useful receptacles for identifying and analyzing solid forms are also within the scope of the invention. Such receptacles may include, for example, slides, films, single-crystal low-background wafers, or an array of vials that may optionally be connected, comprising a material and/or thickness chosen to minimize background interference in the analytical data obtained, as described herein for various aspects of the present teachings.

As used herein, the term “bottom portion” refers to a closed end portion of the microplate and/or well, and may, in practice, include either end of the well or both ends of the well, regardless of orientation of the microplate.

In one exemplary embodiment is disclosed a microplate comprising a body defining a plurality of wells, each of the wells having at least one bottom portion configured to allow for transmission of X-rays during X-ray powder diffraction analysis with minimized background interference in the X-ray powder diffraction data.

In another exemplary embodiment is disclosed a microplate comprising a body defining a plurality of wells, each of the wells having at least one bottom portion, wherein the at least one bottom portion comprises polypropylene and has a thickness ranging from about 1 micron to about 1 millimeter, such as about 37.5 microns.

In another exemplary embodiment is disclosed a method of reducing background interference in XRPD data, the method comprising obtaining the X-ray powder diffraction data on a sample in a microplate comprising a body defining a plurality of wells, wherein the wells have at least one bottom portion, and wherein the at least one bottom portion is configured to allow for transmission of X-rays with minimized background interference in the X-ray powder diffraction data.

In another exemplary embodiment is disclosed a method of reducing background interference in XRPD data, the method comprising obtaining the X-ray powder diffraction data on a sample in a microplate comprising a body defining a plurality of wells, wherein the wells have at least one bottom portion, and wherein the at least one bottom portion comprises polypropylene and has a thickness ranging from about 1 micron to about 1 millimeter, such as about 37.5 microns.

In another exemplary embodiment is disclosed a method of obtaining improved XRPD data on a sample comprising obtaining the XRPD data on a sample in a microplate wherein the microplate comprises a body defining a plurality of wells, wherein the wells have at least one bottom portion, and wherein the at least one bottom portion is configured to allow for transmission of X-rays with minimized background interference in the XRPD data.

In another exemplary embodiment is disclosed a system for obtaining improved XRPD data on a sample comprising an X-ray diffractometer and a microplate comprising a body defining a plurality of wells wherein the wells have at least one bottom portion, wherein the at least one bottom portion is configured to allow for transmission of X-rays with minimized background interference in the X-ray powder diffraction data, wherein the X-ray diffractometer comprises a plate holder, and wherein the microplate is loaded onto the plate holder and X-rays are transmitted through the sample and the bottom portion with minimized background interference from the at least one bottom portion.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings,

FIG. 1 is a perspective view of an exemplary 96-well microplate according to various aspects of the present teachings;

FIG. 2 is a plan view of an exemplary 96-well microplate according to various aspects of the present teachings;

FIG. 3 is a cross-sectional view taken from 3-3 of FIG. 2;

FIG. 4 is a cross-sectional view taken from 4-4 of FIG. 2;

FIGS. 5 and 5a are different exemplary configurations of cross-sectional views taken from 5-5 of FIG. 2, and represent exemplary wells according to various aspects of the present teachings;

FIG. 6 is an exemplary X-ray powder diffractogram comparing XRPD patterns of alumina obtained using a conventional flat bottom microplate according to the prior art, and using a microplate according to an exemplary embodiment of the invention; and

FIG. 7 is an exemplary X-ray powder diffractogram comparing XRPD patterns showing only the background interference in or contribution to the XRPD data obtained when using an empty conventional flat bottom microplate according to the prior art, and by an empty microplate according to an exemplary embodiment of the invention.

### DESCRIPTION OF EXEMPLARY EMBODIMENTS

Reference will now be made in greater detail to exemplary embodiments of the invention, examples of which are illustrated in the accompanying drawings. Wherever possible, the same reference numbers will be used throughout the drawings to refer to the same or like parts.

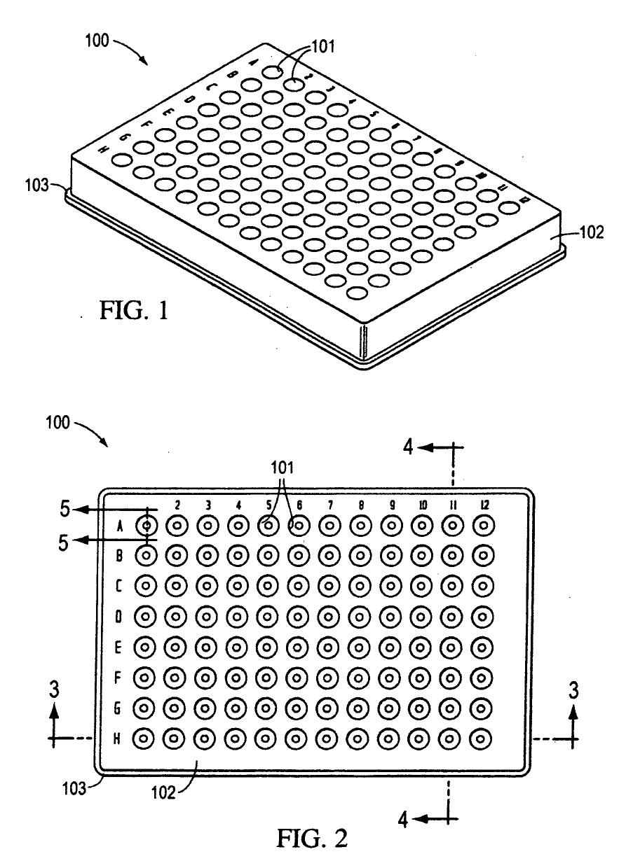

As seen in FIGS. 1 and 2, an exemplary embodiment of a microplate 100 according to various aspects of the present teachings defines a body 102, a microplate skirt 103, and a plurality of wells 101. The microplate skirt 103 generally is configured to rest against a surface on which the microplate 100 sits, thereby lifting the body 102 and wells 101 slightly above such surface. The microplate skirt 103 may extend substantially around a perimeter (e.g., outer edge) of the microplate 100, as illustrated in FIGS. 1 and 2.

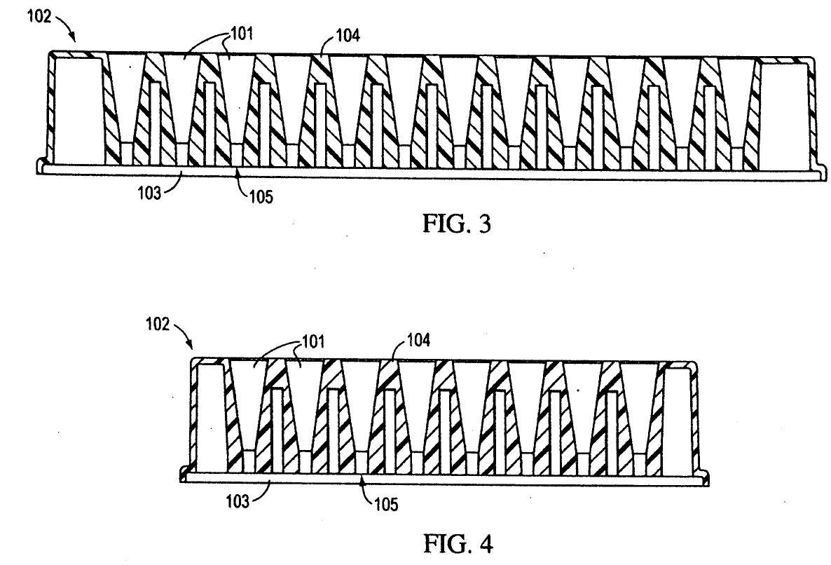

FIGS. 3 and 4 are cross-sectional views of FIG. 2 taken from 3-3 and 4-4, respectively. The bottom portion 105 can also be seen in FIGS. 3 and 4, and forms the closed end of the wells 101. In the exemplary embodiment as seen in FIGS. 3 and 4, the microplate body 102 and bottom portion 105 may optionally be integrally formed, i.e. may be one-piece. In other exemplary embodiments, the microplate 100 may be multi-piece, such as, for example, two pieces. When the microplate 100 is multi-piece, the body 102 and bottom portion 105 may, for example, be manufactured separately and the bottom portion 105 of the microplate 100 may subsequently be attached to the body 102 by various methods known in the art, such as, for example, mechanical means, heat sealing, and/or laser sealing.

The cross-sectional views of FIGS. 3 and 4 also show the thickness of the side walls 104 of the wells 101 which, in various embodiments, may be thin, such as, for example, as thin as possible while still permitting manufacture, for example to allow for the transfer of heat between the wells 101, if desired.

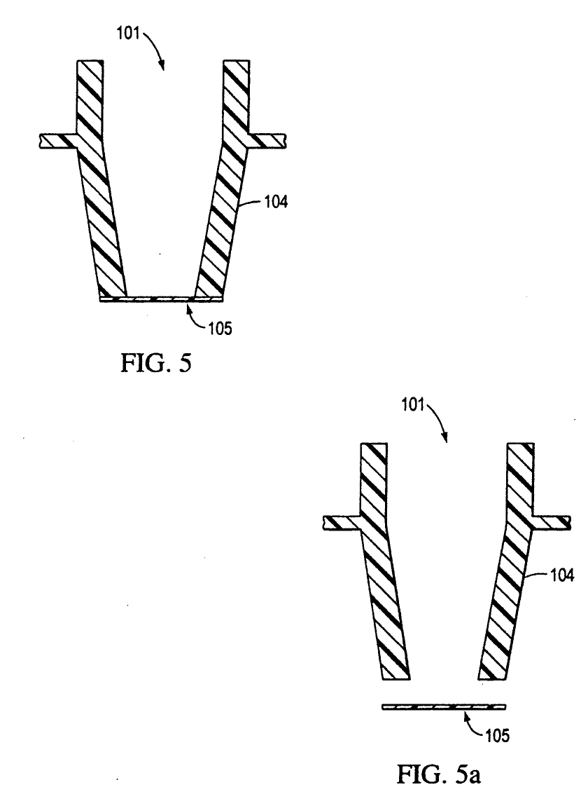

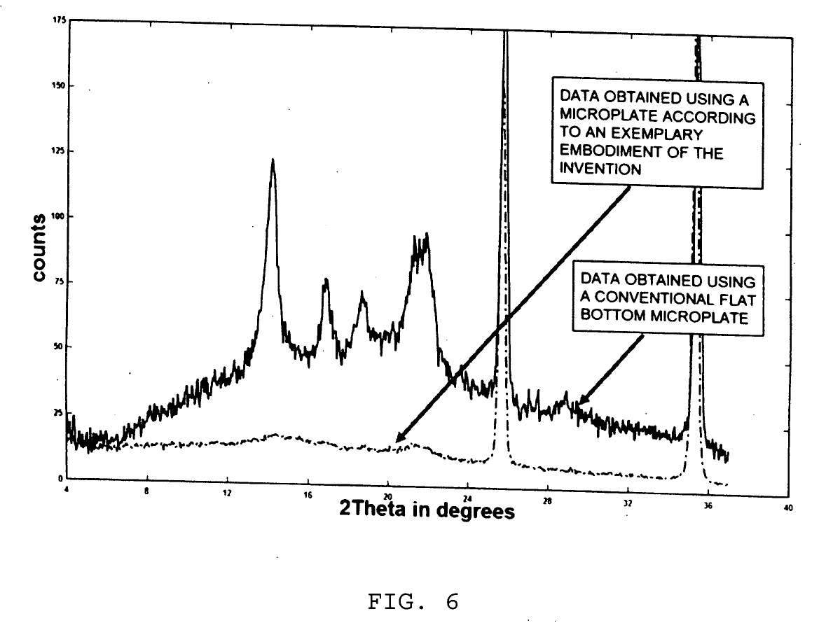

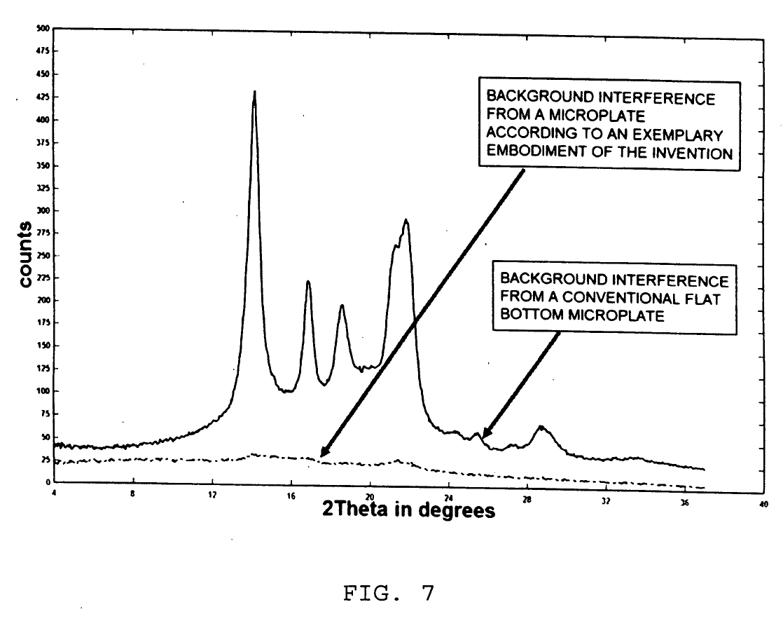

As depicted in the cross-sectional view of the exemplary wells 101 of FIGS. 5 and 5a, the well 101 may be integrally formed with the bottom portion 105 or may be formed separately from the bottom portion 105.

As can be seen in FIGS. 3, 4, 5, and 5a, in various exemplary embodiments, the wells 101 of the microplate 100 can be shaped in a conical, frustoconical, or cylindrical shape, or any combination thereof, in order to minimize background interference from the well 101 itself during analysis of any sample, as well as to maximize the volume of the well and optimize the size, shape, and placement of the solid to be analyzed. For example, the wells 101 of FIG. 4 are frustoconical at the upper section and circular-cylindrical at the lower section. As another example, the well 101 of FIGS. 5 and 5a is circular-cylindrical at the upper section and frustoconical at the lower section. Thus, in various exemplary embodiments, when XRPD is performed on a sample, the shape of the well, such as, for example, the combination of frustoconical and cylindrical shapes, may reduce the amount of background interference in the data obtained and improve the quality of the data obtained.

In various exemplary embodiments, the bottom portion 105 may comprise any material with sufficient properties to minimize background interference with analysis such as, for example, XRPD, Raman, IR, near IR, and/or optical microscopy, so as to minimize the amount of background interference present in the data obtained. In further exemplary embodiments, the bottom portion 105 may be of appropriate thickness to minimize background interference with analysis such as, for example, XRPD, Raman, IR, near IR, and/or optical microscopy, so as to minimize the amount of background interference present in the data obtained. In one exemplary embodiment, the body 102 and bottom portion 105 are formed separately and the bottom portion 105 may comprise polypropylene, such as a polypropylene film. The bottom portion 105 can have, for example, a thickness ranging from about 1 micron to about 1 millimeter, such as from about 3 microns to about 100 microns. For example, the thickness may be about 37.5 microns.

Although the present invention herein has been described with reference to various exemplary embodiments, it is to be understood that these embodiments are merely illustrative of the principles and applications of the present invention. Those having skill in the art would recognize that a variety of modifications to the exemplary embodiments may be made, including modifications to the number and arrangement of various parts, materials, and methodologies, such as, for example, the number of wells, shape of the wells, material for and/or thickness of the bottom portion, etc., without departing from the scope of the invention.

Moreover, it should be understood that various features and/or characteristics of differing embodiments herein may be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the following claims.

What is claimed is:

1. A microplate comprising:
a body defining a plurality of wells, each of the wells having at least one bottom portion configured to allow for transmission of X-rays during X-ray powder diffraction analysis with minimized background interference in the X-ray powder diffraction data.

2. The microplate of claim 1, wherein the at least one bottom portion has a thickness ranging from about 1 micron to about 1 millimeter.

3. The microplate of claim 2, wherein the at least one bottom portion has a thickness of about 37.5 microns.

4. The microplate of claim 1, wherein the at least one bottom portion comprises polypropylene.

5. The microplate of claim 4, wherein the at least one bottom portion comprises a polypropylene film.

6. The microplate of claim 5, wherein the film is heat-sealed to the body.

7. The microplate of claim 1, wherein the wells have a shape chosen from conical, cylindrical, frustoconical, or any combination thereof.

8. A microplate comprising:
a body defining a plurality of wells, each of the wells having at least one bottom portion,
wherein the at least one bottom portion comprises polypropylene and has a thickness ranging from about 1 micron to about 1 millimeter.

9. The microplate according to claim 8, wherein the at least one bottom portion has a thickness of about 37.5 microns.

10. The microplate according to claim 8, wherein the at least one bottom portion comprises a film of polypropylene which is heat-sealed onto the body.

11. A method of reducing background interference in X-ray powder diffraction data, the method comprising:
obtaining the X-ray powder diffraction data on a sample in a microplate comprising a body defining a plurality of wells, wherein the wells have at least one bottom portion, and wherein the at least one bottom portion is configured to allow for transmission of X-rays with minimized background interference in the X-ray powder diffraction data.

12. The method according to claim 11, wherein the at least one bottom portion has a thickness ranging from about 1 micron to about 1 millimeter.

13. The method according to claim 12, wherein the at least one bottom portion has a thickness of about 37.5 microns.

14. The method according to claim 11, wherein the at least one bottom portion comprises polypropylene.

15. The method according to claim 11, wherein the wells have a shape chosen from conical, cylindrical, frustoconical, or any combination thereof.

16. A method of reducing background intereference in X-ray powder diffraction data, the method comprising:
obtaining the X-ray powder diffraction data on a sample in a microplate wherein the microplate comprises a body defining a plurality of wells, wherein the wells have at east one bottom portion, and wherein the at least one bottom portion comprises polypropylene and has a thickness ranging from about 1 micron to about 1 millimeter.

17. The method according to claim 16, wherein the at least one bottom portion has a thickness of about 37.5 microns.

18. The method according to claim 16, wherein the at least one bottom portion comprises a film of polypropylene which is heat-sealed onto the body.

19. A method of obtaining improved X-ray powder diffraction data on a sample comprising obtaining the X-ray powder diffraction data on a sample in a microplate wherein the microplate comprises a body defining a plurality of wells, wherein the wells have at least one bottom portion, and wherein the at least one bottom portion is configured to allow for transmission of X-rays with minimized background interference in the X-ray powder diffraction data.

20. The method according to claim 19, wherein the at least one bottom portion has a thickness ranging from about 1 micron to about 1 millimeter.

21. The method according to claim 20, wherein the at least one bottom portion has a thickness of about 37.5 microns.

22. The method according to claim 19, wherein the at least one bottom portion comprises polypropylene.

23. The method according to claim 19, wherein the wells have a shape chosen from conical, cylindrical, frustoconical, or any combination thereof.

24. A system for obtaining improved X-ray powder diffraction data on a sample comprising an X-ray diffractometer and a microplate comprising a body defining a plurality of wells,
wherein the wells have at least one bottom portion,
wherein the at least one bottom portion is configured to allow for transmission of X-rays with minimized background interference in the X-ray powder diffraction data,
wherein the X-ray diffractometer comprises a plate holder,
and wherein the microplate is loaded onto the plate holder and X-rays are transmitted through the sample and the bottom portion with minimized background interference from the at least one bottom portion.

25. A method of reducing background interference in Raman data, the method comprising:
obtaining the Raman data on a sample in a microplate comprising a body defining a plurality of wells, wherein the wells have at least one bottom portion, and wherein the at least one bottom portion is configured to allow for transmission of Raman laser light with minimized background interference in the Raman data.

26. The method according to claim 25, wherein the at least one bottom portion has a thickness ranging from about 1 micron to about 1 millimeter.

27. The method according to claim 26, wherein the at least one bottom portion has a thickness of about 37.5 microns.

28. The method according to claim 25, wherein the at least one bottom portion comprises polypropylene.

29. The method according to claim 25, wherein the wells have a shape chosen from conical, cylindrical, frustoconical, or any combination thereof.

30. A method of reducing background interference in Raman data, the method comprising:
obtaining the Raman data on a sample in a microplate wherein the microplate comprises a body defining a plurality of wells, wherein the wells have at least one bottom portion, and wherein the at least one bottom portion comprises polypropylene and has a thickness ranging from about 1 micron to about 1 millimeter.

31. The method according to claim 30, wherein the at least one bottom portion has a thickness of about 37.5 microns.

32. The method according to claim 30 wherein the at least one bottom portion comprises a film of polypropylene which is heat-sealed onto the body.

33. A method of obtaining improved Raman data on a sample comprising obtaining the Raman data on a sample in a microplate wherein the microplate comprises a body defining a plurality of wells, wherein the wells have at least one bottom portion, and wherein the at least one bottom portion is configured to allow for transmission of Raman laser light with minimized background interference in the Raman data.

34. The method according to claim 33, wherein the at least one bottom portion has a thickness ranging from about 1 micron to about 1 millimeter.

35. The method according to claim 34, wherein the at least one bottom portion has a thickness of about 37.5 microns.

36. The method according to claim 33, wherein the at least one bottom portion comprises polypropylene.

37. The method according to claim 33, wherein the wells have a shape chosen from conical, cylindrical, frustoconical, or any combination thereof.

38. A system for obtaining improved Raman data on a sample comprising a Raman spectrometer and a microplate comprising a body defining a plurality of wells,
wherein the wells have at least one bottom portion,
wherein the at least one bottom portion is configured to allow for transmission of Raman laser light with minimized background interference in the Raman data,
wherein the Raman spectrometer comprises a plate holder,
and wherein the microplate is loaded onto the plate holder and Raman laser light is transmitted through the sample and the bottom portion with minimized background interference from the at least one bottom portion.
